(19) United States
(12) Patent Application Publication
(10) Pub. No.: US 2006/0162586 A1
(43) Pub. Date: Jul. 27, 2006

(54) Method for inkjet printing light colors on dark textiles

(76) Inventors: Scott O. Fresener, Scottsdale, AZ (US); S. Michael Fresener, Mesa, AZ (US)

Correspondence Address: ETHERTON LAW GROUP, LLC, 5555 E. VAN BUREN STREET, SUITE 100, PHOENIX, AZ, 85008, US

(21) Appl. No.: 11/101,084

(22) Filed: Apr. 7, 2005

Related U.S. Application Data
(60) Provisional application No. 60/647,560, filed on Jan. 27, 2005.

(51) Int. Cl. B41F 15/12; B41F 15/10

(52) U.S. Cl. 101/115; 101/114

(57) ABSTRACT

A method and apparatus for printing on dark textiles such as black t-shirts is disclosed. The method includes screen printing an underbase onto the textile and then using an inkjet printer to print an image over the underbase. In the preferred embodiment, a white, opaque image is screen printed onto a black t-shirt, followed by inkjet printing a white image on top of the screen-printed image.

### CROSS-REFERENCE TO RELATED APPLICATIONS

This application claims the benefit of co-pending provisional application No. 60/647,560 filed on Jan. 27, 2005.

### FIELD OF INVENTION

This invention relates to printing images onto articles of clothing and other textiles. This invention relates particularly to methods and apparatus for inkjet printing light colors on dark textiles.

### BACKGROUND

Screen printing is commonly used to print designs and other decoration onto articles of clothing and other textiles such as T-shirts, ball caps, shorts, and towels. These images are used for decoration or advertising and frequently include various logos or other types of decoration such as the name of a sports team or organization.

In order to screen print an image onto textile, a stencil of the desired image is created on mesh fabric that has been stretched across a frame. The mesh stencil is placed over the article of clothing in preparation for printing. Ink is applied by squeegee to the stencil and is forced through holes in the mesh onto the substrate, creating the image.

Textiles are typically screen printed with graphic images by using either a rotary press (also referred to as a “speed table”) or a single-shirt printing station. The rotary press is a base that has arms supporting several platens whereby each platen is capable of supporting an article of clothing during the screen-printing process. The screen printing process includes various steps that are completed at certain stations. As the base rotates, each platen is moved from station to station and a different step in the screen-printing process is completed. Each station may have a different function, such as loading, printing, curing, unloading and the like. This allows higher production because multiple steps in the screen-printing process can be carried out simultaneously. Single-shirt printing stations differ from rotary presses in that they hold one item and print one color at a time and do not rotate about an axis. Since they only hold one item at a time, the entire screen printing process for each textile is completed within the single-shirt printing station.

Despite screen printing's advantages, certain textiles do not screen print well. Dark textiles are the hardest to screen print because the ink is typically not opaque enough to completely conceal the color of the textile being printed. In order to resolve this problem, a light-color base is first printed onto the textile which is referred to as an “underbase.” This underbase serves to block out the darker colored textile and enables other colors to be effectively screen printed on top of the underbase. Multi-colored shirts are typically screen printed in this manner. Although screen printing multi-colored shirts as discussed above is effective, it is time consuming and labor intensive as each color must be individually screen printed on the textile.

Another popular method of printing textiles is inkjet printing using ink jet printers. Inkjet printing uses high pressure to force inks through tiny nozzles and, as a result, can produce very finely detailed images. Inkjet printing offers a number of potential benefits over conventional screen printing methods. Inkjet printing is computer controlled and the digital printing eliminates the set-up expense associated with screen preparation and enables cost-effective short run production.

But, inkjet printing still fails to provide for an efficient method of printing light colors such as the color white on textiles. Inkjet printing fails in this regard because typical inkjet textile ink is extremely transparent and therefore will not provide enough ink coverage on a dark textile. Inkjet printing white ink is further complicated because the molecules of the white pigment, typically titanium dioxide, are too big to fit through the inkjet nozzles to produce an even spray. Consequently, inkjet printing has not been able to print light colors on dark textiles. The ability to inkjet white designs on black t-shirts has been particularly elusive.

Therefore, it is an object of the present invention to provide an efficient method and apparatus for printing light colors on dark textiles. It is also an object of this invention to provide a method for inkjet printing light colors on dark textiles. It is also an object to inkjet white designs on black textiles. It is yet a further object to provide a method that combines the advantages of screen printing and inkjet printing to print light colored inks on dark textiles such as t-shirts.

### SUMMARY OF THE INVENTION

This invention is a method and apparatus for printing light colors on dark textiles. The method comprises screen printing an underbase on the textile, followed by inkjet printing the desired image on top of the underbase. In the preferred embodiment, a black t-shirt is placed on a platen of a rotary press. At a first station, an image is screen-printed onto the t-shirt to form the underbase. The white image may have varying degrees of opacity and typically is slightly smaller than the desired image. The platen is rotated to a second station and the screen print ink is cured. The platen is rotated to a third station and the desired image is printed by inkjet onto the underbase. In the preferred embodiment, a white, opaque image is screen printed onto a black t-shirt, followed by inkjet printing a white image on top of the screen-printed image. The preferred apparatus comprises a rotary speed table that cooperates with a screen print head, one or more cure units, and an inkjet print head.

### BRIEF DESCRIPTION OF THE DRAWINGS

FIG. 1 is an illustration of a first embodiment using a rotary press; and

FIG. 2 is a block diagram of a third embodiment using a single-shirt printing press.

### DETAILED DESCRIPTION OF THE INVENTION

This invention combines screen printing with inkjet printing to print light colors on dark textiles. The method of the present invention comprises the steps of screen printing an underbase on a textile and then inkjet printing the desired image over the underbase. In the preferred embodiments, traditional screen printing equipment is used in conjunction with one or more ink jet printers. The method of the present invention is denoted as 10.

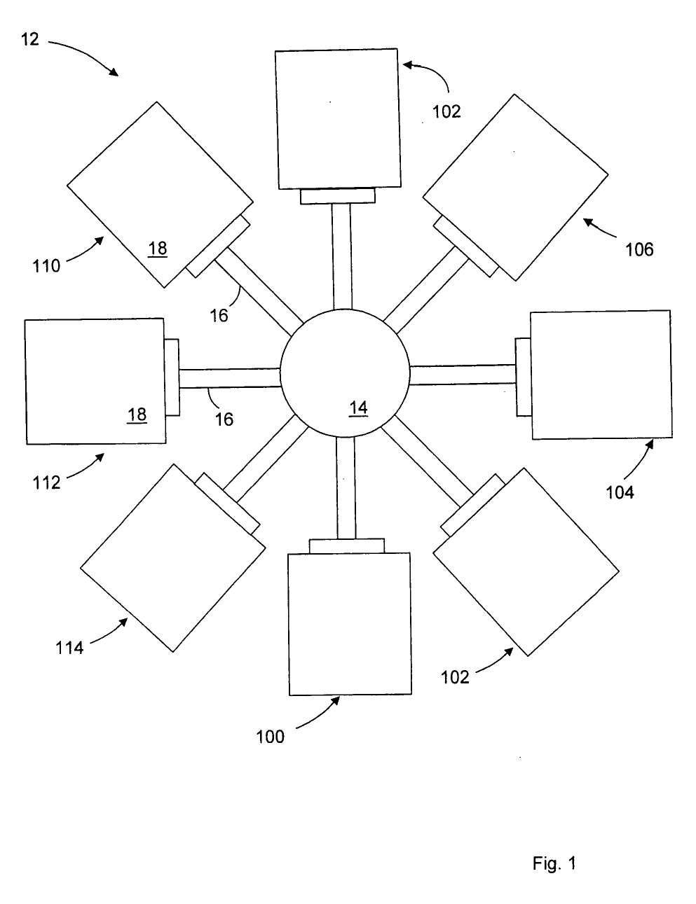

The first embodiment of method 10 uses a rotary press 12. Rotary press 12 is preferably a rotary speed table and comprises a base 14 with a series of arms 16, each of which supports a platen 18 which carries the textile being printed. As shown in FIG. 1, platens 18 rotate about an axis on base 14 to enable each platen 18 to pass through a series of stations 100-114 wherein a different step in method 10 occurs. Method 10 will now be described in detail by way of example.

A textile item such as a garment is loaded on platen 18 of a rotary press 12 at station 100. Platen 18 is rotated to station 102 wherein ink is screen printed onto the textile to form the underbase by a screen print head using known screen printing methods. In the preferred embodiment, the underbase is a light color such as white and is opaque, such as that created with plastisol garment screen printing ink, waterbased garment screen printing ink, or discharge garment screen printing ink. The underbase may have varying degrees of opacity and typically is slightly smaller than the desired image, known in the art as “choking” the image.

Platen 18 is rotated to station 104 to cure the underbase. Curing is used herein to mean the hardening of the ink, whether by evaporating solvent or polymerizing the ink by heat or ultra-violet light, as is known in the art. In the preferred embodiment, a curing apparatus is used that utilizes either ultra-violet light or heat. After curing, platen 18 is rotated to station 106 wherein an image is inkjet printed onto the textile. The inkjet printing is preferably accomplished by using known equipment, such as an ink jet printer. An example of an excellent inkjet printer for use at station 106 is the FAST T-JET™ printer or the FAST T-JUMBO™ distributed by the U.S. Screen Printing Institute of Tempe, Arizona. In this preferred embodiment, the ink jet printer would be in perfect registry to enable it to print the identical image two or more times to enhance the colors of the image. The ink used by the inkjet printer can be any known inkjet printer ink, an example of which is FASTINK™ ink which is also produced and distributed by the U.S. Screen Printing Institute.

In alternative embodiments, multiple inkjet printers may be used at several stations 108 and 110 to print additional ink onto the underbase. In that regard, each ink jet printer can print an identical image on the textile to enhance the trueness of the colors or each inkjet printer at each station may be dedicated to applying ink of a certain ink color to the textile. But, if additional stations 108-110 are not desired, the user simply rotates platen 18 to a final station 112 to cure the inkjet ink skipping stations 108-110. Curing the inkjet ink at station 112 is also optional, and if desired, the textile can be removed at a final station 114 following the inkjet printing. In this preferred embodiment, the textile is an article of clothing such as a black t-shirt and the ink inkjet printed to the underbase is white ink.

The second embodiment also uses rotary press 12, but eliminates curing the underbase thereby skipping station 104 and proceeding directly to station 106. Eliminating the curing step is dependent upon which type of ink is screen-printed onto the textile at station 102 as is known in the art. The textile is loaded on platen 18 of a rotary press 10 at station 100 before being rotated to station 102 where a light opaque image (preferably white) is screen-printed onto the textile to form the underbase. Platen 18 is then rotated to station 106 where the desired image is inkjet printed onto the textile. Optionally, platen 18 may be rotated to station 112 to cure the inkjet ink. The textile is then removed from the platen 18 at station 114.

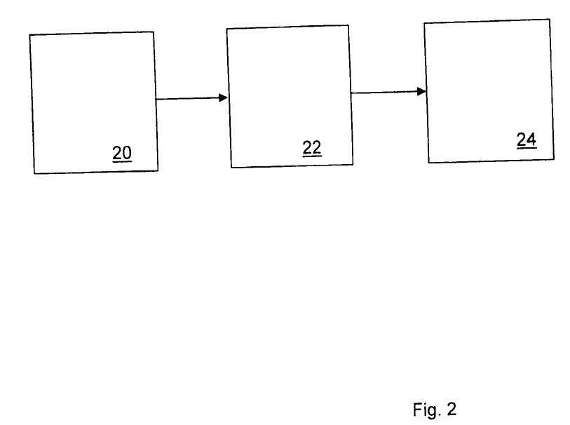

FIG. 2 illustrates a third embodiment of method 10 using a single-shirt printing press 20. First, the textile is laid onto printing press 20. Then, using known methods, the preferably light-colored underbase is screen printed on the textile using printing press 20. The textile is then placed within a curing apparatus 22 to cure the underbase. Curing apparatus 22 can be any known type of curing device, but in this preferred embodiment, curing apparatus 22 uses either heat or ultra-violet light. Then, the desired image is inkjet printed on top of the underbase by an inkjet printer 24. Similar to the first and second embodiments, ink jet printer is preferably in perfect registry to allow for the printer to print an image two or more times on a piece of textile. Additionally, two or more inkjet printers could be used as discussed above in these embodiments.

The fourth embodiment also uses printing press 20, but eliminates curing the underbase with curing apparatus 22. Instead, the underbase is screen printed on the textile using printing press 20 before the desired image is inkjet printed on top of the underbase by inkjet printer 24.

In the embodiments described herein, the screen print head, inkjet printer, and the cure units may be stand-alone devices that operate independently, or they may be interconnected to cooperate with each other and the rotary press 12.

As can be seen, method 10 provides for an efficient process of printing images on textiles such as garments. Method 10 enables for light-colored inks such as white ink to be easily applied to dark textiles such as black t-shirts with relative ease by combining the screen printing technology with inkjet printing.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

We claim:

1. A method of printing an image on a textile comprising:
a) screen printing an underbase on the textile; and
b) inkjet printing an image on top of the underbase.

2. The method according to claim 1 further comprising curing the underbase before inkjet printing an image on top of the underbase.

3. The method according to claim 1 wherein the textile is placed on a rotary press and remains on the rotary press during the screen printing and inkjet printing.

4. The method according to claim 3 wherein the rotary press comprises a station for screen printing the underbase and a station for inkjet printing.

5. The method according to claim 1 wherein the underbase is white.

6. The method according to claim 5 wherein the image printed on the underbase by the inkjet printing is white.

7. The method according to claim 6 wherein the textile is black.

8. A method of printing an image on an article of clothing comprising:
a) screen printing an opaque underbase on the article of clothing;
b) curing the opaque underbase; and
c) inkjet printing an image on top of the opaque underbase.

9. The method according to claim 8 further comprising curing the image that was printed on the opaque underbase.

10. The method according to claim 8 wherein a rotary press defines a series of stations and is used to pass the article of clothing through the series of stations whereby screen printing the opaque underbase occurs at a first station, the curing of the opaque underbase occurs at a second station, and inkjet printing of the image on top of the opaque underbase occurs at a third station.

11. The method according to claim 10 wherein the rotary press further defines a fourth station where that image printed on the article of clothing by the inkjet printing is cured.

12. The method according to claim 8 wherein the opaque underbase is white.

13. The method according to claim 8 wherein the image printed on the article of clothing by the inkjet printing is white.

14. The method according to claim 11 wherein the image printed on the article of clothing by the ink jet printing is white.

15. The method of claim 14 wherein the article of clothing is a black t-shirt.

16. A method of printing a white image on an article of clothing comprising:
a) providing a rotary press comprising:
i) a base,
ii) a plurality of arms connected to the base,
iii) a plurality of platens whereby each platen supports an article of clothing, and
iv) whereby each platen is attached to an arm and forms a station wherein a specific task of printing a white image on an article of clothing occurs;
b) loading the article of clothing on one of the platens at one station;
c) screen printing a white underbase on the article of clothing using a screen print head at a second station;
d) curing the white underbase with a device at a third station; and
e) inkjet printing a white image on the white underbase at a fourth station with an inkjet printer.

17. The method according to claim 16 further comprising curing the white image printed on the article of clothing by the inkjet printing.

18. The method according to claim 16 wherein the article of clothing is a dark color.

19. The method according to claim 18 wherein the article of clothing is a black t-shirt.

20. The method according to claim 16 wherein the rotary press cooperates with the screen print head, the ink jet printer, and the curing device.

21. An apparatus for printing a light-colored image on an article of clothing comprising:
a) a rotary press comprising:
i) a base,
ii) a plurality of arms connected to the base,
iii) a plurality of platens whereby each platen supports an article of clothing, and
iv) whereby each platen is attached to an arm and forms a station wherein a specific task of printing a light-colored image on an article of clothing occurs;
b) a screen printing device located at one station for applying a light-colored underbase to the article of clothing; and
c) an inkjet printer at a second station for inkjet printing light-colored ink on the underbase.

22. The apparatus of claim 21 further comprising a device to cure the light-colored underbase located at a third station.

23. The apparatus of claim 21 further comprising a device to cure the light-colored ink applied by the inkjet printer at a fourth station.

24. The apparatus of claim 21 wherein the light-colored underbase is white.

25. The apparatus of claim 24 wherein the light-colored ink applied by the ink jet printer is white.

26. The apparatus according to claim 25 wherein the article of clothing is a black t-shirt.
